(19) United States
(12) Patent Application Publication
(10) Pub. No.: US 2019/0190873 A1
(43) Pub. Date: Jun. 20, 2019

(54) CONTINUED INFLUENCED THREADS

(71) Applicant: International Business Machines Corporation, Armonk, NY (US)

(72) Inventors: Hernan A. Cunico, Holly Springs, NC (US); Liam S. Harpur, Skerries (IE); John Rice, Tramore (IE); Asima Silva, Holden, MA (US)

(21) Appl. No.: 15/843,410

(22) Filed: Dec. 15, 2017

(51) Int. Cl. H04L 12/58

(52) U.S. Cl. CPC H04L 51/32; H04L 51/16

(57) ABSTRACT

A method and system for continued influenced threads, and more specifically, for augmenting a thread on a channel based on affinity. Other threads on different channels are monitored by analyzing content being discussed in the threads. An affinity with the other threads is identified, in order to establish an association between the threads, based on the analyzed content, wherein the association may be established by determining whether the analyzed content is shared between the threads. The thread is then modified based on the identified affinity, by copying at least a portion of the other threads.

### BACKGROUND

The present invention relates generally to a method and system for continued influenced threads with regard to social media accounts.

When adding information onto a social media thread or source (e.g., a collaboration thread in a community), users may gather information from other threads or sources. Often, the interplay of these sources and the association between threads is significant, in view of the behavior of the users. There is need, then, for being cognizant of the relationships between threads and sources going forward.

There exist some technologies relating to facilitating social media accounts. However, there remains a need in the art for methods and systems for continued influenced threads. The present invention satisfies that need.

### SUMMARY

The invention provided herein has a number of embodiments useful, for example, in implementing a system and method for continued influenced threads, and more specifically, for augmenting a thread on a channel based on affinity.

The system and method monitor other threads on different channels, which may include analyzing content being discussed in the threads.

The system and method identify an affinity with one of the other threads, which may comprise establishing an association between the threads based on the analyzed content.

The association may be established between the threads by determining whether the analyzed content is shared between the threads.

The association may be established between the threads depending on a frequency of the analyzed content being shared between the threads.

The association may be established between the threads by calculating quotients corresponding to the analyzed content shared between the threads, and combining the quotients to determine the affinity. This calculation may include assigning weights to the quotients and establishing the association between the threads based on the assigned weights.

The system and method modify the thread based on the identified affinity, which may comprise copying at least a portion of the other threads.

### BRIEF DESCRIPTION OF THE DRAWINGS

Referring now to the drawings in which like reference numbers represent corresponding parts throughout:

FIG. 1 is a pictorial representation of a system for implementing continued influenced threads, according to one embodiment.

FIG. 2 is a block diagram illustrating how the continued influenced threads are implemented, according to one embodiment.

FIG. 3 is a block diagram illustrating a use case for continued influenced threads, according to one embodiment.

FIG. 4 is a flowchart illustrating the steps performed by the system implementing the continued influenced threads, according to one embodiment.

### DETAILED DESCRIPTION

In the following description, reference is made to the accompanying drawings which form a part hereof, and in which is shown by way of illustration one or more specific embodiments in which the invention may be practiced. It is to be understood that other embodiments may be utilized and structural and functional changes may be made without departing from the scope of the present invention.

Overview

The present invention comprises a computer-implemented method and system for augmenting collaboration and social media threads based on thread affinity. The system monitors the collaboration and social media threads on different channels, and based on their affinity, it can establish associations between those threads that can be used for augmenting either thread, thereby realizing continued influenced threads.

In one embodiment, the system monitors collaboration and social media threads and analyzes the content being discussed. This includes the context, tone and sentiment of the responses from those involved in the threads.

The system calculates quotients corresponding to each of the elements analyzed in the threads (e.g., topic, context, sentiment, frequency of posts, number of people involved, etc.). The combination of these quotients determines an affinity factor that can then be compared across multiple threads and channels. The system can assign different weights to each of those quotients, so that, when certain criteria is reached, a connection or association can be established between those threads.

In another embodiment, the system determines user behavior by analyzing whether any content from one thread is used on another thread. Depending on the frequency of content referenced or copied from one thread to another, the system creates a secondary type of association (for example, a permanent reference) that shows up on the involved threads.

In another embodiment, the system uses “breadcrumbs” style content source tracing. Any snippet reused on another thread (e.g., a small piece or brief extract of a thread is copied verbatim, or re-typed and modified, onto another thread) is traced to its original source thread.

One aspect of the present invention includes the analysis and identification of isolated threads and, based on individual and group behavior between two threads, associating the isolated threads based on individual and group behavior affinity. Another aspect of the present invention also includes determining affinity of isolated threads based on common elements. In addition, an aspect of the present invention includes snippet source tracing.

The advantages of the present invention include surfacing to the users of one thread, relevant and ongoing communications on a different thread.

Hardware and Software Environment

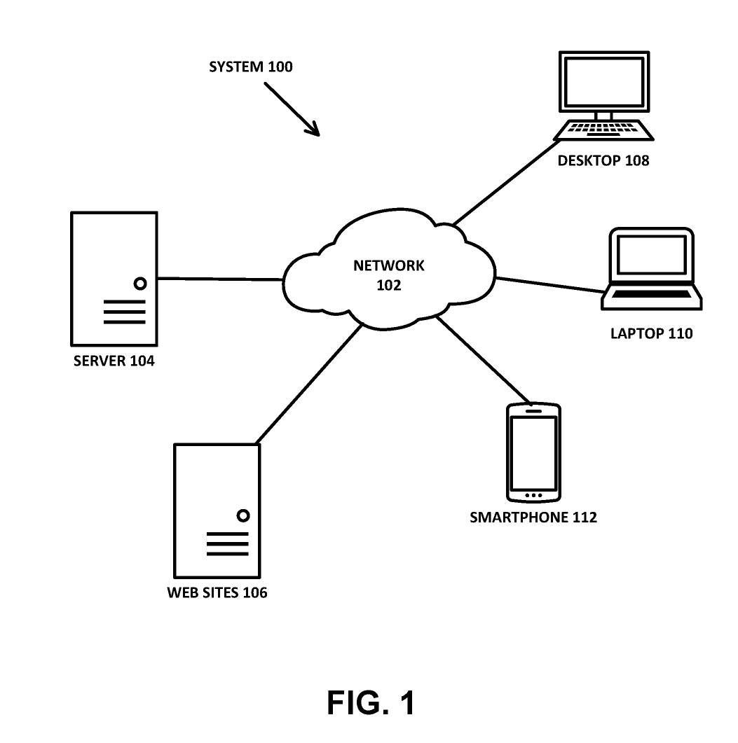

FIG. 1 is a pictorial representation of a system 100 for implementing continued influenced threads, according to one embodiment.

The system 100 includes a network 102, which is the medium used to provide communications links between various devices and computers connected together within the system 100. In the depicted example, the network 102 may be the Internet or another network.

A server computer 104 is connected to the network 102, along with one or more collaboration or social media web sites 106. In addition, client devices 108, 110, 112 are connected to the server computer 104 and social media web sites 106 via the network 102. These client devices 108, 110, 112 may be, for example, desktop computers 108, laptop or notebook computers 110, smartphones 112 and other devices.

The server computer 104, web sites 106, and client devices 108, 110, 112, are typically comprised of one or more processors, random access memory (RAM), read-only memory (ROM), and other components such data storage devices and data communications devices. Moreover, the server computer 104, web sites 106, and client devices 108, 110, 112, execute one or more computer programs operating under the control of an operating system. These computer programs perform various functions and steps as described in more detail below.

In this system 100, the server 104 monitors the behavior of one or more users interacting with the web sites 106 using their client devices 108, 110, 112, and notices if a significant group of users sources content, sentiment or opinion in another communication channel or source, e.g., when looking at a Facebook™ thread, the user accesses a WhatsApp™ thread to find some information. If it is determined that a significant number of users do that, then that source may be defined as a significant source. That behavior, in turn, may be used to augment the original Facebook™ thread to additionally show the relevant WhatsApp™ information going forward.

For example, consider a scenario where a virtual reality (VR) thread in Linkedln™ is being viewed by Peter. Peter decides he wants to find out what his colleague Joe thinks about VR, and accesses a related WhatsApp™ chat, and then uses information from that related WhatsApp™ chat to base a comment in the original VR thread in Linkedln™. The system 100 monitors the specific WhatsApp™ chat for comments by Joe, and then those comments going forward may optionally be overlayed onto the Linkedln™ thread. Optionally, that information can be made visible to others, e.g., viewable by close network contacts.

The advantage of such a system 100 is surfacing the relevant and ongoing flow of communication. Currently, a user needs to copy/paste content through multiple web site 106 threads and there is no automated flow control. Another advantage of such a system 100 is, over time, understanding the influence of a source to a group in a particular collaboration, and using that learned information to optimize that collaboration.

Continued Influenced Threads

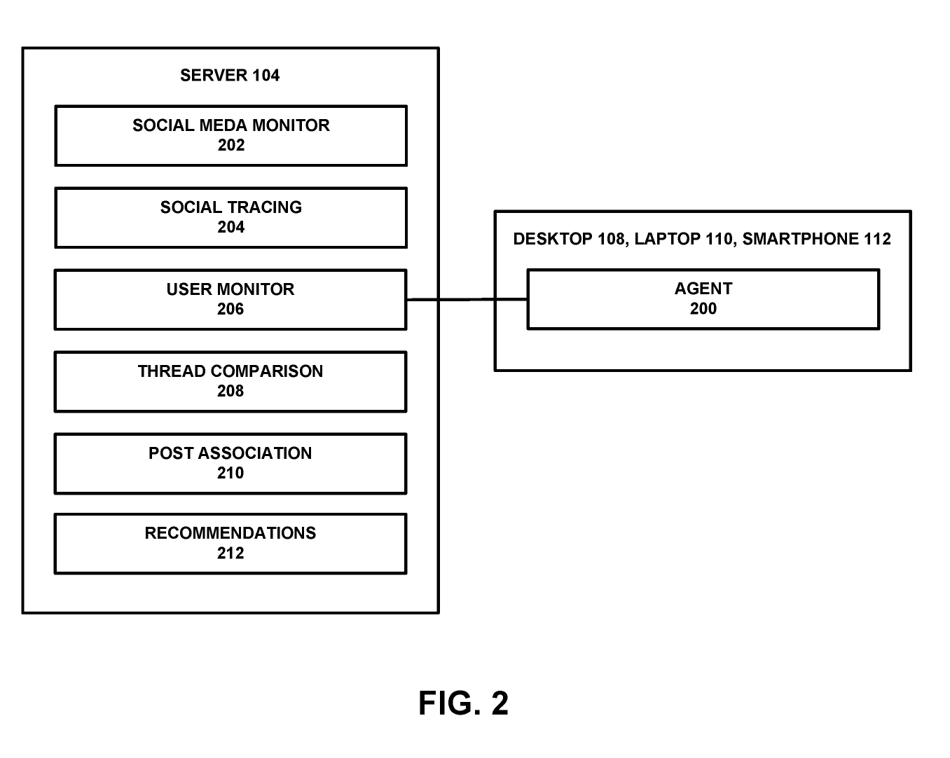

FIG. 2 is a block diagram illustrating how the continued influenced threads are implemented by the system 100, according to one embodiment. In this embodiment, the continued influenced threads are implemented using:
an agent 200 is executed on the user's devices 108, 110, 112 to track the user's activities, behaviors, reactions, etc., on the web sites 106; and
a plurality of modules 202-212 are executed on the server 104 that communicate with the agent 200 installed on the user's devices 108, 110, 112 to analyze the user's activities, behaviors, reactions, etc., on the web sites 106 as tracked by the agent 200.

In alternative embodiments, however, these functions may be wholly performed on the server 104 or client devices 108, 110, 112.

To analyze the user's activities, behaviors, reactions, etc., on the web sites 106 as tracked by the agent 200, the server 104 implements the following modules and functionality.

A Social Media Monitor module 202 monitors and analyzes threads on different web site 106 channels. It identifies threads and the content being discussed, including the context, tone and sentiment of the responses from those involved in the threads. The Social Media Monitor module 202 calculates a quotient corresponding to each of the elements analyzed in the threads (e.g., topic, context, sentiment, frequency of posts, number of people involved, etc.). The combination of these quotients determines an affinity factor. Different weights may be assigned to each of those quotients. These weights can be driven by different factors depending on the element being analyzed, for example, activity level, intensity of sentiments, number of followers, etc.

A Source Tracing module 204 creates a unique Tracing ID associating a snippet (and all the other information analyzed in Social Media Monitor module 202) and the web site 106 channel source. Every time the user copies a snippet from a thread, that snippet carries a Tracing ID with it. If the user changes that snippet, the Tracing ID persists as long as certain quotients remain unchanged (for example, “topic”). In this way, any snippet reused on another thread (e.g., copied verbatim, or re-typed and modified) can be traced to its original source thread.

A User Monitor module 206 analyzes user participation in web site 106 channels. It analyzes the type of web site 106 and threads the user participates in and the type of participation. Further, it analyzes if the user is leveraging or reusing information from one thread into another (from interaction with the Source Tracing module 204). This module 206 is also a learning module that understands user behavior, which is needed later on by a Recommendations module 212.

A Thread Comparison module 208 compares the quotients and affinity factors between the user's active threads against any other threads on any other web site 106 channel the user is subscribed to.

Based on data provided by the other modules, a Post Association module 210 determines what other posts or threads can be associated with the user's active posts.

A Recommendations module 212 recommends to the user a specific action corresponding to the active thread based on previous user behavior. Some recommendation examples could include adding a reference to the other thread, or pre-selecting a snippet from another thread to be inserted in the current thread.

Use Case

The system 100 can be enabled for any collaboration or social media web site 106 that takes input from a client device 108, 110, 112 of a registered user. The system 100 uses a monitoring method to capture steps and behaviors when the user is creating, editing and/or updating threads on the client device 108, 110, 112. The system 100 captures the source of content that is used in the thread. So, if the user is updating a Linkedln™ thread and copying content from a WhatsApp™ or Facebook™ group chats or threads, then the system 100 maps the sources for future exchange. The system 100 also augments the threads.

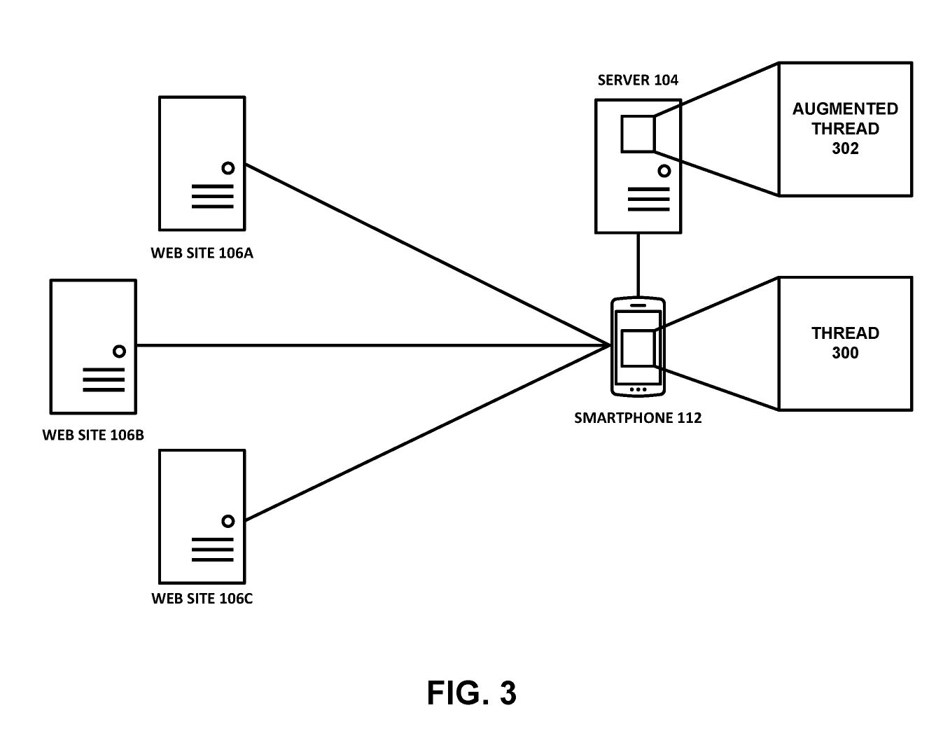

Consider the following use case illustrated in FIG. 3. A user starts a new thread 300 on their smartphone 112 for one of the web sites 106A, wherein the thread 300 includes both user and group content. As part of the research in compiling the thread 300, the user takes input from other web sites 106B, 106C of one or more social media applications. The server 104 monitors the interaction between the user's smartphone 112 and the thread 300 during the compilation and content gathering process. If the user triggers a certain threshold of data gathering from a given source, then the server 104 tags that as a source of valuable content, and therefore, as a source for an augmented thread 302. As the thread 300 continues, the valued sources of content will be mapped to the augmented thread 302.

A data structure created and stored on the server 104 for the thread 300 that shows the linkage between sources is provided below:

| | % Related | % Related | |
|---|---|---|---|
| | to Original | to Original | |
| Source ID | Thread (User) | Thread (Group) | Recommendations |
| Thread X on Web | 14% | 68% | Show |
| Site 106A | | | |
| Thread Y on Web | 49% | 44% | Show |
| Site 106B | | | |
| Thread Z on Web | 32% | 8% | Prevent |
| Site 106C | | | |

The “Source ID” identifies the threads on the web sites 106, the “% Related to Original Thread (User)” indicates the percentage of content in the threads on the web sites 106 that is related to the user's contributions to the thread 300, the “% Related to Original Thread (Group)” indicates the percentage of content in the threads on the web sites 106 that is related to other members of the group contributions to the thread 300, and “Recommendations” indicate whether the augmented thread 302 should be visualized (Shown) or not (Prevent).

The system 100 ascertains how related the two sources are (e.g., using client 112 side monitoring by the agent 200 to ascertain if a user takes content from the other sources). How related two sources are may be based on:
The frequency members of the group access the other source and revert back.
The timing of the interaction (e.g., is the cumulative time spent significant enough to denote the relationship).
The importance of the author or involved users in the situation.

Based on these considerations, a decision is made by the server 104 whether to visualize (“Show”) the content of the augmented thread 302 for the user and/or the group, or not (“Prevent”). That visualization can be configured by the user.

Flowchart

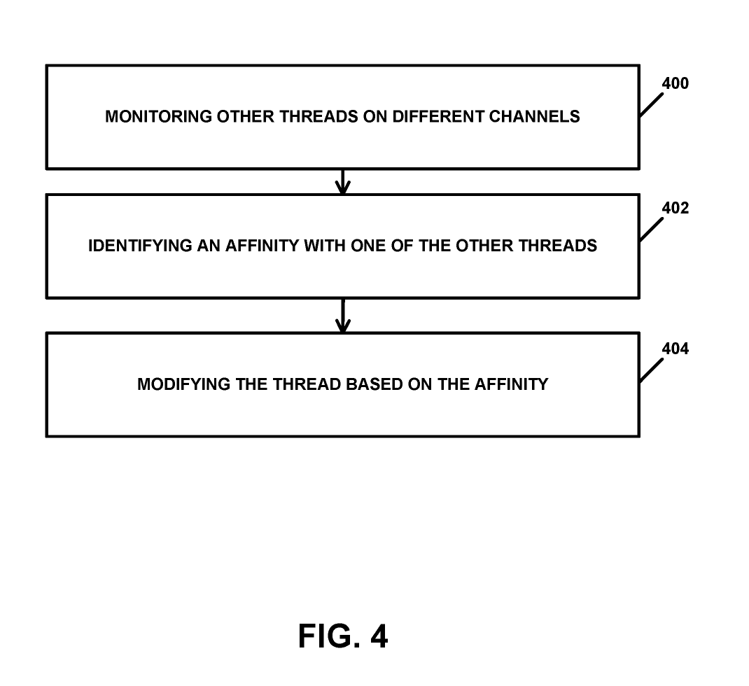

FIG. 4 is a flowchart illustrating the steps performed by the system 100 when implementing the computer-implemented method of this invention, according to one embodiment. Specifically, these steps comprise the system 100 augmenting a thread on a channel based on affinity, in order to realize continued influenced threads.

Block 400 represents the system 100 monitoring other threads on different channels. This may include analyzing content being discussed in the threads.

Block 402 represents the system 100 identifying an affinity with one of the other threads. This may include establishing an association between the threads based on the analyzed content. The association may be established between the threads by determining whether the analyzed content is shared between the threads. For example, the association may be established between the threads depending on a frequency of the analyzed content being shared between the threads. In another example, the association may be established between the threads by calculating quotients corresponding to the analyzed content shared between the threads, and combining the quotients to determine the affinity. This may include assigning weights to the quotients and establishing the association between the threads based on the assigned weights.

Block 404 represents the system 100 modifying the thread based on the identified affinity, in order to realize continued influenced threads. This may include copying at least a portion of the other threads.

Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

### CONCLUSION

This concludes the description of the various embodiments of the present invention. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Since many embodiments of the invention can be made without departing from the spirit and scope of the invention, the invention resides in the claims hereinafter appended.

What is claimed is:

1. A computer-implemented method, comprising:
augmenting a thread on a channel, by:
monitoring other threads on different channels;
identifying an affinity with one of the other threads; and
modifying the augmented thread based on the identified affinity.

2. The method of claim 1, wherein monitoring the other threads comprises analyzing content being discussed in the threads.

3. The method of claim 2, wherein identifying the affinity comprises establishing an association between the threads based on the analyzed content.

4. The method of claim 3, wherein establishing the association comprises determining whether the analyzed content is shared between the threads.

5. The method of claim 4, wherein establishing the association comprises establishing the association between the threads depending on a frequency of the analyzed content being shared between the threads.

6. The method of claim 4, wherein establishing the association comprises calculating quotients corresponding to the analyzed content shared between the threads, and combining the quotients to determine the affinity.

7. The method of claim 6, wherein calculating the quotients comprises assigning weights to the quotients and establishing the association between the threads based on the assigned weights.

8. The method of claim 1, wherein the thread is modified by copying at least a portion of the other threads to the augmented thread.

9. A computer-implemented system, comprising:
one or more computers programmed for augmenting a thread on a channel, by:
monitoring other threads on different channels;
identifying an affinity with one of the other threads; and
modifying the augmented thread based on the identified affinity.

10. The system of claim 9, wherein monitoring the other threads comprises analyzing content being discussed in the threads.

11. The system of claim 10, wherein identifying the affinity comprises establishing an association between the threads based on the analyzed content.

12. The system of claim 11, wherein establishing the association comprises determining whether the analyzed content is shared between the threads.

13. The system of claim 12, wherein establishing the association comprises establishing the association between the threads depending on a frequency of the analyzed content being shared between the threads.

14. The system of claim 12, wherein establishing the association comprises calculating quotients corresponding to the analyzed content shared between the threads, and combining the quotients to determine the affinity.

15. The system of claim 14, wherein calculating the quotients comprises assigning weights to the quotients and establishing the association between the threads based on the assigned weights.

16. The system of claim 9, wherein the thread is modified by copying at least a portion of the other threads to the augmented thread.

17. A computer program product, the computer program product comprising a computer readable storage medium having program instructions embodied therewith, the program instructions executable by one or more computers to cause the computers to perform a method, comprising:
augmenting a thread on a channel, by:
monitoring other threads on different channels;
identifying an affinity with one of the other threads; and
modifying the augmented thread based on the identified affinity.

18. The computer program product of claim 17, wherein monitoring the other threads comprises analyzing content being discussed in the threads.

19. The computer program product of claim 18, wherein identifying the affinity comprises establishing an association between the threads based on the analyzed content.

20. The computer program product of claim 17, wherein the thread is modified by copying at least a portion of the other threads to the augmented thread.
